(19) United States
(12) Patent Application Publication
(10) Pub. No.: US 2006/0285132 A1
(43) Pub. Date: Dec. 21, 2006

(54) Electrophotographic image forming apparatus

(75) Inventor: Se-il Kwon, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/362,117

(22) Filed: Feb. 27, 2006

(30) Foreign Application Priority Data
Jun. 21, 2005 (KR) 2005-53514

(51) Int. Cl. G06K 15/12

(52) U.S. Cl. 358/1.7

(57) ABSTRACT

An electrophotographic image forming apparatus includes a main body; an image formation unit removably mounted to the main body and having at least two cartridges disposed adjacently to each other; a plurality of memory members disposed on each cartridge to face one another; and a communication unit disposed among the memory members for communication with the memory members.

### CROSS-REFERENCE TO RELATED APPLICATIONS

This application claims the benefit of Korean Patent Application No. 2005-53514, filed Jun. 21, 2005, in the Korean Intellectual Property Office, the disclosure of which is incorporated herein by reference.

### BACKGROUND OF THE INVENTION

1. Field of the Invention

Aspects of the present invention relate to an electrophotographic image forming apparatus. More particularly, the aspects of the present invention relate to an electrophotographic image forming apparatus in which an image formation unit is removably mounted to a main body, and a communication unit of the main body non-contactingly receives information from a memory member provided in the image formation unit.

2. Description of the Related Art

In general, electrophotographic image forming apparatuses generate an image on a recording medium using an electrophotographic image formation system. Typical electrophotographic image forming apparatuses include electrophotographic copiers, electrophotographic printers (laser beam printers), facsimile machines, and multi-function apparatuses.

Image forming apparatuses may have various types of structures. In a first type, for example, an electrifying unit, a developing unit, or a cleaning unit is integrated with a photoconductive drum in one cartridge, and the cartridge is removably mounted to a main body of the image forming apparatus. In a second type, more than one of an electrifying unit, a developing unit, and a cleaning unit are integrated with a photoconductive drum in one cartridge, and the cartridge is removably mounted to a main body of the apparatus. In a third type, a developing unit and a photoconductive drum are integrated in one cartridge which is removably mounted to a main body of the apparatus. In a fourth type, a photoconductive unit and a developing unit are integrated in one cartridge while a developer supply unit is separately provided to be removably mounted to a main body of the apparatus.

Management and maintenance of the main body or a process cartridge of electrophotographic image forming apparatuses as described above are carried out as follows.

A memory member for storing service information is built into the process cartridge. The service information may include the type, lifespan (expiration date), production number, and place of production of the process cartridge. Regarding the lifespan, notification may be given through an operation panel formed on the main body of the apparatus when the lifespan of the process cartridge is expired. The notification can be carried out through a connection between a connector of an interface board mounted to the main body and a connector mounted at the process cartridge, the connection being achieved when the process cartridge is mounted to the main body.

For the connection between the memory member and the interface board, various methods can be adopted as follows.

FIG. 1A shows a memory member of a process cartridge being connected to an interface board mounted to the main body of the apparatus, according to a conventional art. FIG. 1B is an enlarged view showing the memory member mounted on a front of the process cartridge.

Referring to FIGS. 1A and 1B, an interface board 5 is mounted on a side of a main body 1, and the side is perpendicular to a direction for mounting and separating a process cartridge 3. A memory member 7 is mounted on a side of the process cartridge 3 that faces the interface board 5. The memory member 7 has a connection terminal 7a for connection with a connector 5a of the interface board 5.

FIG. 2A shows another example of a connection between a memory member of a process cartridge and an interface board mounted to the main body of an apparatus, according to a conventional art. FIG. 2B is an enlarged view showing the memory member mounted on the side of the process cartridge.

Referring to FIGS. 2A and 2B, an interface board 15 is mounted on the side of a main body 11 of the apparatus and a memory member 17 is mounted on the side of the process cartridge 13, so that a connection terminal 17a of the memory member 17 is connected with a connector 15a formed on a slideway of the interface board 15 when the interface board is mounted into the main body 11.

Besides the above, the connection between an interface board and a memory member can be achieved through a connection method that involves opening and closing a cover after the process cartridge is mounted to the main body.

However, in the conventional structures, since the memory members 7 and 17 and the interface boards 5 and 15 are connected through connection terminals 7a and 17a, respectively, the connections are not stable. A dedicated structure to maintain a predetermined tension in the connection terminal 7a or 17a is required, thereby causing an increase in the manufacturing cost and the number of parts.

Even when the stability of the structure is secured, a data transmission error may happen in the conventional structure due to external vibration generated during data communication or due to contamination on contacting surfaces.

In order to overcome such problems, a structure that non-contactingly receives information of the process cartridge has been used.

A non-contact structure is described in Japanese Patent Publication No. 2003-195725, wherein a non-contact communication mechanism is provided between a memory member mounted to the process cartridge and a communication unit of the main body.

Another example for a non-contact structure is disclosed in Japanese Patent Publication No. 2002-328580, wherein a process cartridge that is a consumables unit is provided with a memory member having a communication means capable of communicating with the main body by electromagnetic waves in the non-contact state, so as to communicate information with a communication means formed at the main body of the image forming apparatus.

In yet another example as disclosed in Japanese Patent Publication No. 2000-330434, memory members are attached respectively to a process cartridge and a developer supply unit, and a communication means is provided to the main body of the image forming apparatus for non-contact communication with the respective memory members.

However, in the above conventional arts (Japanese Patent Publication Nos. 2003-195725, 2002-328580, and 2000-330434), each cartridge must have a memory member, and an equal number of communication means must be formed at the main body, thereby complicating the structure and increasing the number of parts.

### SUMMARY OF THE INVENTION

An aspect of the present invention is to solve at least the above problems and/or disadvantages and to provide at least the advantages described below. Accordingly, an aspect of the present invention is to provide a simplified data communication structure in an electrophotographic image forming apparatus between memory members, such as memory members mounted on a process cartridge and a developer supply unit, and an interface board formed on the main body of the image forming apparatus.

Additional aspects and/or advantages of the invention will be set forth in part in the description which follows and, in part, will be obvious from the description, or may be learned by practice of the invention.

In order to achieve the above-described and/or other aspects of the present invention, there is provided an electrophotographic image forming apparatus comprising a main body; an image formation unit removably mounted to the main body and having at least two cartridges disposed adjacent to each other; a plurality of memory members respectively disposed on each cartridge to face one another; and a communication unit disposed among the memory members that communicates with the memory members.

The cartridges of the image formation unit have a length direction, and the communication unit is disposed at a first end, at an opposite end, or at a middle location between the first end and the opposite end of the cartridges with respect to the length direction of the cartridges.

The cartridges are mounted and separated along the length direction thereof, and the communication unit is mounted on a side of the main body, the side perpendicular to a mounting and separating direction of the image formation unit.

The cartridges comprise a process cartridge that carries out image development and a developer supply cartridge that supplies developer to the process cartridge.

The memory members may comprise radio frequency identification (RFID) memory chips. The memory members may be attached to the cartridges by adhesive.

The electrophotographic image forming apparatus may further comprise a bracket for supporting the communication unit at the side of the main body. The bracket has a slot for insertion of the communication unit and an opening for exposing both sides of the communication unit.

According to the above electrophotographic image forming apparatus, the structure for data communication can be simplified by providing the process cartridge and the developer supply unit with the memory members for storing information, respectively, and providing the main body with the communication unit for simultaneous communication with the plurality of memory members.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A shows a memory member of a process cartridge being connected to an interface board formed at a main body of an apparatus, according to a conventional art;

FIG. 1B shows an enlarged view of the memory member of FIG. 1A mounted on a front of the process cartridge;

FIG. 2A shows another example of a connection between the memory member of the process cartridge and the interface board mounted to the main body of the apparatus, according to a conventional art;

FIG. 2B shows an enlarged view in which the memory member of FIG. 2A is mounted on the side of the process cartridge;

FIG. 3 schematically shows an electrophotographic image forming apparatus according to an embodiment of the present invention;

FIG. 4 shows the electrophotographic image forming apparatus of FIG. 3, and more specifically, provides a partially exploded view showing a disposition relationship between a communication unit of a main body of the apparatus and a memory member of a process cartridge; and

FIG. 5 is an enlarged view showing the memory member mounted to each of the process cartridge and the developer supply unit, and the communication unit disposed among the memory members;

FIG. 6 is a plan view of a cartridge mounting part formed at a side of the main body, for explaining a mounting structure of the communication unit; and

FIG. 7 is an enlarged perspective view of a portion “VI” of FIG. 6.

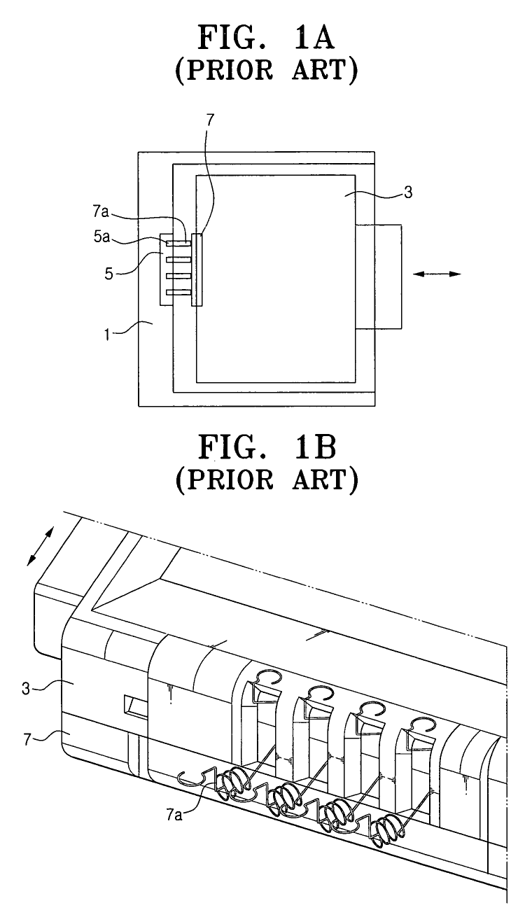

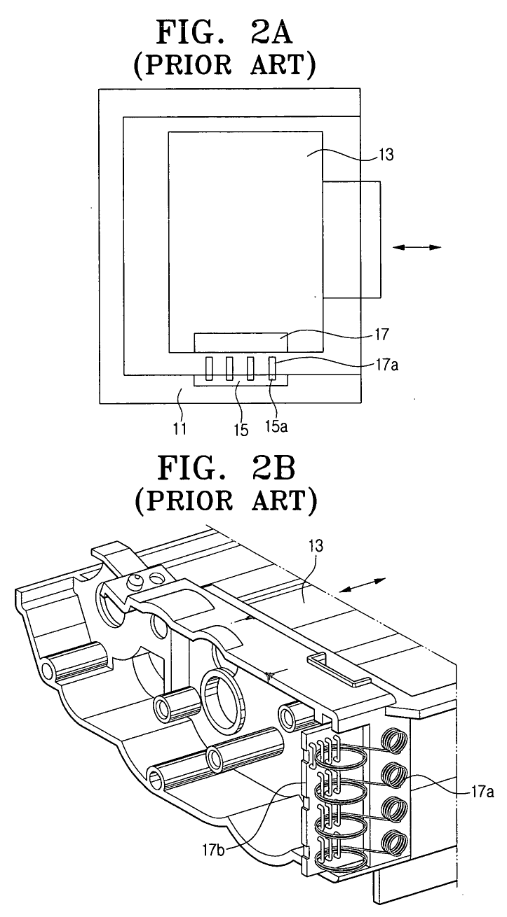

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

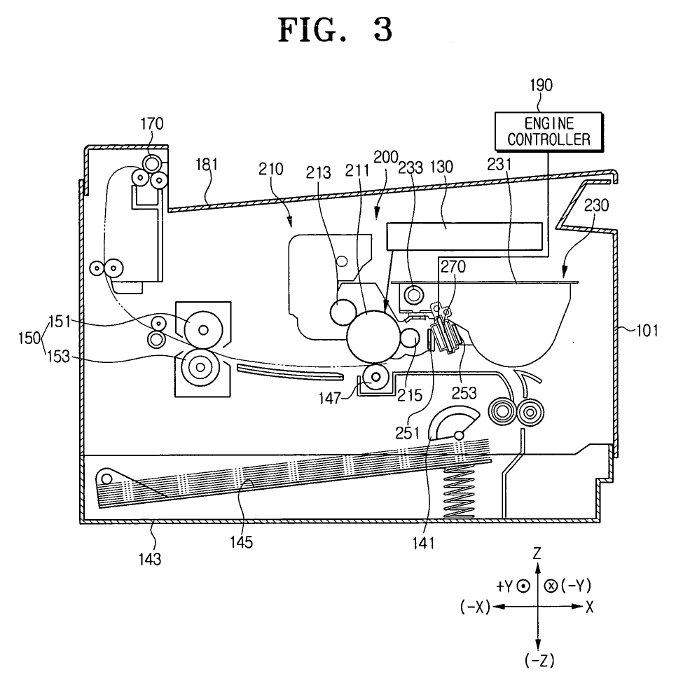

FIG. 3 schematically shows an electrophotographic image forming apparatus according to an embodiment of the present invention.

Referring to FIG. 3, an electrophotographic photoconductive medium 211 (hereinafter, referred to as “photoconductive drum”) has a drum shape. The photoconductive drum 211 is rotated in a certain direction. While being rotated, the photoconductive drum 211 is electrically charged to a predetermined electric potential by a first electrifying roller 213 which is an electrifying unit. A predetermined laser beam is projected from a laser scanning unit 130 onto a surface of the charged photoconductive drum 211, thereby generating an electrostatic latent image.

The electrostatic latent image formed on the photoconductive drum 211 is made visible through developer supplied by a developing roller 215, which is a developing unit.

Recording media 145 stacked in a paper supply cassette 143 are fed by a paper feeding roller 141 sheet by sheet toward the photoconductive drum 211. The recording medium 145 is fed to a nip, that is, a contacting area between the photoconductive drum 211 and a transfer roller 147. A developer image formed on the photoconductive drum 211 is sequentially transferred onto a surface of the recording medium 145.

The developer image transferred on the recording medium 145 is fixed on the recording medium 145 by heat and pressure as the recording medium 145 passes through a fixing unit 150 comprising a heating roller 151 and a pressing roller 153.

The recording medium 145 that has passed through the fixing unit 150 is discharged through a discharge unit 170 to a discharged-paper tray 181 formed at the outside of the main body 101.

An engine controller 190, as a main body control unit, controls electrophotographing processes performed by the laser scanning unit 130, an image formation unit 200 and the fixing unit 150, and the movement of the recording medium 145 in the main body 101.

The image formation unit 200 may comprise a process cartridge 210 and a developer supply cartridge 230.

The process cartridge 210 comprises the photoconductive drum 211 and at least one process unit. The process unit comprises the electrifying roller 213 for electrically charging the photoconductive drum 211, the developing roller 215 for developing the electrostatic latent image formed on the photoconductive drum 211, and a cleaning unit (not shown) for cleaning away the developer remaining on the surface of the photoconductive drum 211.

The developer supply cartridge 230 provides the developer received in a developer receptacle 231 to the process cartridge 210 and for this, comprises a developer supply roller 233. As the developer supply roller 233 rotates, the developer is supplied into the process cartridge 210 through an opening (not shown) formed at the developer receptacle 231.

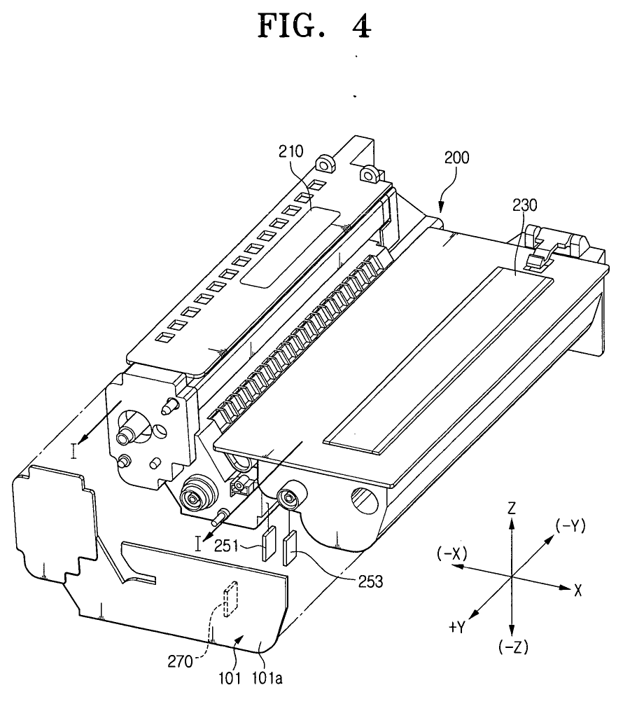

Hereinbelow, management for the replacement of the process cartridge 210 and the developer supply cartridge 230 will be described with reference to FIGS. 4 through 7.

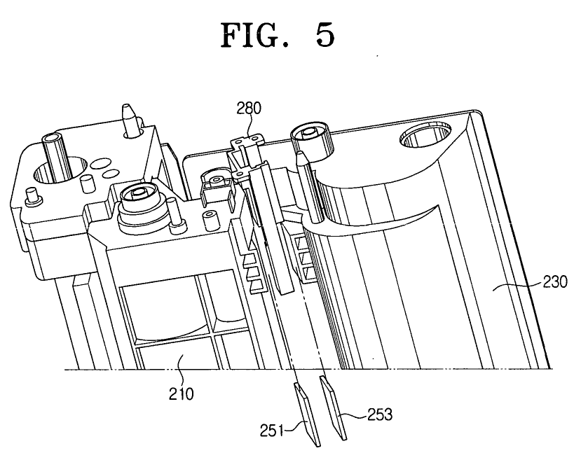

FIG. 4 shows the electrophotographic image forming apparatus of FIG. 3, and more specifically, shows disposition relationships between a communication unit of a main body of the apparatus and memory members of the process cartridge and the developer supply cartridge, respectively. FIG. 5 is an enlarged view showing a memory member mounted to a process cartridge and a memory member mounted to a developer supply unit, and the communication unit disposed between the memory members.

Referring to FIGS. 4 and 5, memory members 251 and 253 are provided to the process cartridge 210 and the developer supply cartridge 230, respectively, to precisely manage the replacement period for the process cartridge 210 and the developer supply cartridge 230. For ease of understanding, both FIGS. 4 and 5 provide a partially exploded view, meaning that the memory members 251 and 253 are shown in isolation and lines extending from the memory members 251 and 253 show the location where the memory members 251 and 253 are attached to the process cartridge 210 and the developer supply cartridge 230, respectively. A main body 101 of the image forming apparatus is provided with a communication unit 270 for reading and writing image formation information of the memory members 251 and 253.

The memory members 251 and 253 store the image formation information of the process cartridge 210 and the developer supply cartridge 230, respectively. The memory members 251 and 253 contain information that is helpful to a user, including predetermined information for replacement management of the process cartridge and developer supply cartridge. The memory members 251 and 253 may comprise a radio frequency identification (RFID) memory chip. The memory members 251 and 253 may be attached to the process cartridge 210 and the developer supply cartridge 230, respectively, by adhesive. The memory members 251 and 253 are disposed to face each other regardless of their specific locations on the process cartridge 210 and the developer supply cartridge 230. In other words, the memory members 251 and 253 may be disposed on a front end, a rear end, or a middle of the process cartridge 210 and the developer supply cartridge 230. Here, the front ends of the process cartridge 210 and the developer supply cartridge 230 are defined based on a mounting direction I of the process cartridge 210 and the developer supply cartridge 230. In FIGS. 4 and 5, the memory members 251 and 253 are mounted on the front ends of the cartridges 210 and 230. Stated another way, the cartridges 210 and 230 of the image formation unit 200 have a length direction, and the communication unit may be disposed at a first end, at an opposite end, with respect to a length direction of the cartridges or at a middle location between the first end and the opposite end.

The communication unit 270 is mounted to the main body 10 and disposed between the memory members 251 and 253 when the image formation unit 200 is mounted to the main body 10. Therefore, disposition of the communication unit 270 may be varied according to disposition of the memory members 251 and 253. According to the FIGS. 4 and 5, the communication unit 270 is mounted to a cartridge mounting part 101 a formed at a side of the main body 101, the side being perpendicular to the mounting direction I of the process cartridge 210 and the developer supply cartridge 230.

The communication unit 270 reads out the information stored in the memory members 251 and 253, such as quantity of remaining developer, in a non-contact state. That is, the communication unit 270 does not require physical contact with the memory members 251 and 253. As the read information is transmitted to an engine controller 190 (FIG. 3), the engine controller 190 determines whether to continue a printing operation of the process cartridge 210. When it is determined that the printing operation can not be continued, the user is notified, for example, through a display unit of an operation panel (not shown), so that the process cartridge 210 or the developer supply cartridge 230 can be replaced with new ones. Moreover, through the operation panel, the user may instruct the communication unit 270 to receive service information from one or more of the memory units and relay the information to the user, by providing the information to a display, such as, for example, a display on the operation panel.

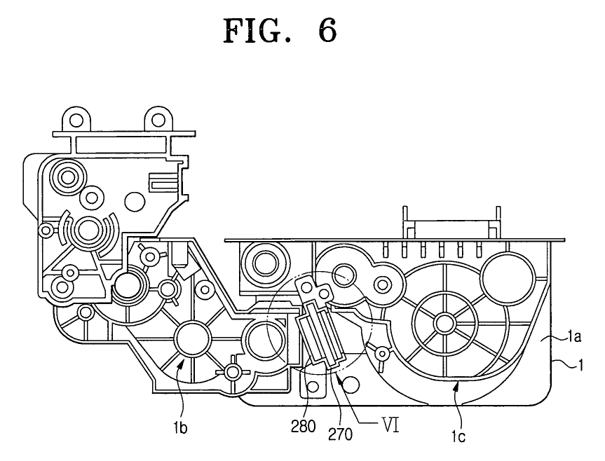

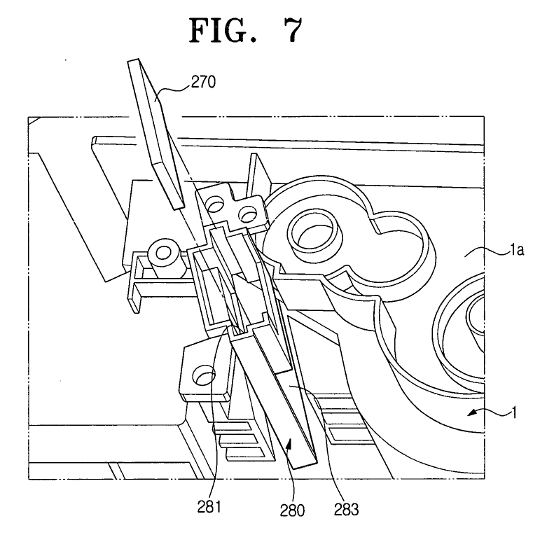

FIG. 6 is a plan view of the cartridge mounting part formed at the side of the main body, illustrating the mounting structure of the communication unit according to an embodiment of the present invention. FIG. 7 is an enlarged perspective view of a portion “VI” of FIG. 6. The image forming apparatus shown in FIGS. 6 and 7 is a type wherein the process cartridge and developer supply cartridge are each mounted to the main body at the opposite end from that shown in FIG. 4. In other words, the cartridge mounting part 1a of FIG. 6 would be a mirror image of the cartridge mounting part 101a of FIG. 4 if the cartridge mounting part 101a of FIG. 4 were turned to show the process cartridge and developing supply cartridge mounting parts.

Referring to FIGS. 6 and 7, a bracket 280 for supporting the communication unit 270 is formed substantially at the center of the cartridge mounting part 1a mounted at the side of the main body 1. The bracket 280 has a slot 281 to insert an interface board constituting the communication unit 270, and openings 283 formed at both sides thereof so that the communication unit 270 may face the memory members 251 and 253. In FIG. 6, a reference numeral 1b denotes a process cartridge mounting part while a reference numeral 1c a developer supply unit mounting part. FIG. 7 is a partially exploded view in that the communication unit 270 is shown in isolation, and lines extending from the communication unit 270 show where the communication unit 270 fits into the slot 281 of the bracket 280. As shown, the communication unit may have opposing faces that, when the communication unit 270 is mounted in the slot 281, match up with the openings 283 formed at the sides of the bracket. In this way, the faces of the communication unit 270 may interface with the memory units 251 and 253 without being blocked by the bracket 280.

Although, in the above description, the image formation unit 200 comprises the process cartridge 210 integrally having the photoconductive drum 211 and the developing unit, and the developer supply cartridge 230, the present invention is not limited to this structure but may apply to other various structures, such as, for example, the first to third types described in the description of the related art. Moreover, in an image forming apparatus that has more than two removable cartridges, each having a memory member mounted thereon, the communication unit may be shaped so that a single communication unit can receive information from all of the memory members. For example, the communication unit may have a number of faces that can be positioned to interface with a plurality of memory members when the cartridges to which they are mounted are inserted in the image forming apparatus

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electrophotographic image forming apparatus comprising:
a main body;
an image formation unit removably mounted to the main body and having at least two cartridges disposed adjacent to each other;
a plurality of memory members respectively disposed on each cartridge to face one another; and
a communication unit disposed among the memory members, to communicate with the memory members.

2. The electrophotographic image forming apparatus of claim 1, wherein the cartridges of the image formation unit have a length direction, and wherein the communication unit is disposed at a first end, at an opposite end, or at a middle location between the first end and the opposite end of the cartridges with respect to the length direction of the cartridges.

3. The electrophotographic image forming apparatus of claim 2, wherein the main body comprises a side to which the cartridges of the image formation unit are removably mounted, wherein the cartridges are mounted to and separated from the side by moving the cartridges along the length direction thereof, wherein the side is perpendicular to the length direction of the cartridges, and wherein the communication unit is mounted on the side.

4. The electrophotographic image forming apparatus of claim 1, wherein the cartridges comprise a process cartridge that carries out image development and a developer supply cartridge that supplies developer to the process cartridge.

5. The electrophotographic image forming apparatus of claim 1, wherein the memory members comprise radio frequency identification (RFID) memory chips.

6. The electrophotographic image forming apparatus of claim 5, wherein the memory members are attached to the cartridges by adhesive.

7. The electrophotographic image forming apparatus of claim 3, further comprising a bracket that supports the communication unit at the side of the main body.

8. The electrophotographic image forming apparatus of claim 7, wherein the communication unit has a pair of opposing faces and wherein the bracket has a slot for insertion of the communication unit and openings for exposing both faces of the communication unit.

9. The electrophotographic image forming apparatus of claim 1, wherein each memory unit stores service information relating to the cartridge to which the memory unit is attached.

10. The electrophotographic image forming apparatus of claim 9, wherein at least one memory unit stores service information relating to the lifespan of the cartridge to which the memory unit is attached.

11. The electrophotographic image forming apparatus of claim 10, wherein the at least one memory unit that stores service information relating to the lifespan of the cartridge to which it is attached notifies the communication unit when the lifespan of the cartridge is expired.

12. The electrophotographic image forming apparatus of claim 10, further comprising an engine controller, and wherein the communication unit communicates to the engine controller when the at least one memory unit that stores service information relating to the lifespan of the cartridge to which the memory member is attached notifies the communication unit when the lifespan of the cartridge is expired.

13. The electrophotographic image forming apparatus of claim 10, further comprising an operation panel that interfaces with a user, and wherein the communication unit communicates to the operation panel when the at least one memory unit that stores service information relating to the lifespan of the cartridge to which the memory member is attached notifies the communication unit when the lifespan of the cartridge is expired.

14. The electrophotographic image forming apparatus of claim 10, further comprising an operation panel that interfaces with a user that allows the user to instruct the communication unit to receive and relay stored service information from one of the memory units.

15. An electrophotographic image forming apparatus comprising:
a main body;
an image formation unit removably mounted to the main body and having at least two cartridges disposed adjacent to each other;
a plurality of memory members respectively disposed on each cartridge to face one another; and
a single communication unit disposed among the memory members, to communicate with the memory members.

16. The electrophotographic image forming apparatus of claim 15, wherein each memory unit stores service information relating to the cartridge to which the memory unit is attached.

17. The electrophotographic image forming apparatus of claim 15, wherein at least one memory unit stores service information relating to the lifespan of the cartridge to which the memory unit is attached.

18. The electrophotographic image forming apparatus of claim 17, wherein the at least one memory unit that stores service information relating to the lifespan of the cartridge to which it is attached notifies the communication unit when the lifespan of the cartridge is expired.

19. The electrophotographic image forming apparatus of claim 18, further comprising an engine controller and an operations panel, and wherein the communication unit communicates to the engine controller and the operations panel when the at least one memory unit that stores service information relating to the lifespan of the cartridge to which the memory member is attached notifies the communication unit when the lifespan of the cartridge is expired.

20. The electrophotographic image forming apparatus of claim 16, further comprising an operation panel that interfaces with a user that allows the user to instruct the communication unit to receive and relay stored service information from one of the memory units.
